(19) United States
(12) Patent Application Publication
(10) Pub. No.: US 2025/0050636 A1
(43) Pub. Date: Feb. 13, 2025

(54) LIQUID EJECTION HEAD AND METHOD OF MANUFACTURING LIQUID EJECTION HEAD

(71) Applicant: CANON KABUSHIKI KAISHA, Tokyo (JP)

(72) Inventors: ISAMU YONEDA, Kanagawa (JP); TAKEHO MIYASHITA, Kanagawa (JP)

(21) Appl. No.: 18/795,847

(22) Filed: Aug. 6, 2024

(30) Foreign Application Priority Data
Aug. 8, 2023 (JP) 2023-129445

(51) Int. Cl. B41J 2/14; B41J 2/16

(52) U.S. Cl. CPC B41J 2/14; B41J 2/16; B41J 2/1623; B41J 2002/14491

(57) ABSTRACT

A liquid ejection head having an electrical connection structure includes first leads arranged in one direction along an edge portion of a first electrical wiring member, second leads arranged in the one direction along an edge portion of a second electrical wiring member and facing the corresponding first leads, and an anisotropic conductive film located between the first leads and the second leads and electrically connecting the first leads and the corresponding second leads. The first leads include a first end lead located at one end portion in the one direction, and the first electrical wiring member includes a first additional portion having a raised shape in which at least a portion of the first additional portion is in contact with the first end lead in the one direction.

### BACKGROUND OF THE DISCLOSURE

### Field of the Disclosure

The present disclosure relates to a liquid ejection head and a method of manufacturing a liquid ejection head.

### Description of the Related Art

A technology for electrically connecting electrical wiring members by using an anisotropic conductive film is known. The anisotropic conductive film is pasted to one of the electrical wiring members in advance. Japanese Patent Laid-Open No. 2004-6632 describes disposition of a dummy electrode beside an electrode to prevent the anisotropic conductive film from being peeled from the electrode.

The dummy electrode described in Japanese Patent Laid-Open No. 2004-6632 has a gap between the dummy electrode and the electrode. Accordingly, when an end portion of the anisotropic conductive film is disposed on the gap due to a paste error of the anisotropic conductive film, the anisotropic conductive film is more likely to be peeled starting from the end portion thereof. In particular, in an electrical connection structure of a liquid ejection head that uses a liquid, such as ink, if the anisotropic conductive film is peeled, the liquid may come into contact with an electrical connection portion to reduce the electrical reliability.

### SUMMARY OF THE DISCLOSURE

The present disclosure provides a liquid ejection head having an electrical connection structure in which the anisotropic conductive film is less likely to be peeled.

The liquid ejection head according to the present disclosure having an electrical connection structure, the electrical connection structure includes a plurality of first leads having a raised shape and arranged in one direction along an edge portion of a first electrical wiring member, a plurality of second leads arranged in the one direction along an edge portion of a second electrical wiring member and facing the corresponding first leads, and an anisotropic conductive film located between the plurality of first leads and the plurality of second leads and electrically connecting the plurality of first leads and the corresponding plurality of second leads to each other. The plurality of first leads includes a first end lead located at one end portion in the one direction, and the first electrical wiring member includes a first additional portion having a raised shape, at least a portion of the first additional portion being in contact with the first end lead in the one direction.

Further features of the present disclosure will become apparent from the following description of exemplary embodiments with reference to the attached drawings.

### BRIEF DESCRIPTION OF THE DRAWINGS

FIG. 1 is a perspective view illustrating a main portion of a liquid ejection head according to an embodiment of the present disclosure.

FIG. 2A is a plan view illustrating a first electrical wiring member to which an anisotropic conductive film has been pasted, and FIG. 2B is a plan view illustrating a second electrical wiring member.

FIG. 3A is a partial cross-sectional view of the first electrical wiring member and the second electrical wiring member before being joined to each other, and FIG. 3B is a partial cross-sectional view of the first electrical wiring member and the second electrical wiring member after being joined to each other.

FIG. 4 is a diagram illustrating a device for pasting the anisotropic conductive film to the first electrical wiring member.

FIGS. 5A to 5G are diagrams illustrating a process of pasting the anisotropic conductive film to the first electrical wiring member.

FIGS. 6A to 6C are diagrams illustrating a paste error of the anisotropic conductive film in an X direction.

FIG. 7A to 7C are diagrams illustrating a paste error of the anisotropic conductive film in a Y direction.

FIGS. 8A to 8D are side views illustrating states of an end portion of the anisotropic conductive film.

FIGS. 9A to 9C are diagrams illustrating a mechanism by which an end portion of the anisotropic conductive film is peeled.

FIGS. 10A and 10B are diagrams illustrating a mechanism by which an end portion of the anisotropic conductive film is peeled.

FIGS. 11A and 11B are diagrams illustrating a paste error of the first electrical wiring member having a first additional portion.

FIG. 12 is a diagram illustrating an electrical wiring member according to a comparative example.

FIGS. 13A to 13C are diagrams illustrating modifications.

### DESCRIPTION OF THE EMBODIMENTS

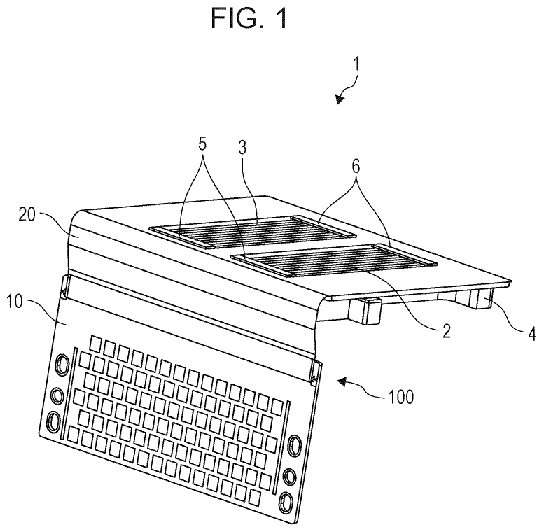

An electrical connection structure 100 according to an embodiment of the present disclosure will be described with reference to FIGS. 1 to 12.

The embodiment is an example of the present disclosure and is not intended to limit the scope of the present disclosure. The following embodiment relates to an electrical connection structure of an inkjet head that ejects ink, but the present disclosure can also be applied to an electrical connection structure of a liquid ejection head that ejects a liquid other than ink. In the following description and drawings, an X direction is a longitudinal direction of an anisotropic conductive film 50, a Y direction is a width direction of the anisotropic conductive film 50 or a direction parallel to a film surface of the anisotropic conductive film 50 and orthogonal to the X direction. The direction orthogonal to the X direction and the Y direction is a Z direction.

### Structure of Liquid Ejection Head

FIG. 1 is a perspective view illustrating a main portion of a liquid ejection head 1. The liquid ejection head 1 includes an element substrate 2 that ejects a single color of ink (black ink) and an element substrate 3 that ejects a plurality of colors of ink (color ink). The liquid ejection head includes a support member 4 that has ink supply ports (not illustrated) and supports the element substrates 2 and 3. The element substrates 2 and 3 are fixed to the support member 4 with respective ejection ports aligned with the ink supply ports. A second electrical wiring member 20 is fixed to the support member 4. The element substrates 2 and 3 are electrically connected to the second electrical wiring member 20 by a technique, such as wire bonding or inner lead bonding. The electrical connection portions between the element substrates 2 and 3 and the support member 4 are sealed with sealing materials 5 and 6. The second electrical wiring member 20 is a flexible wiring substrate. The second electrical wiring member 20 is electrically and physically connected to a first electrical wiring member 10 by the anisotropic conductive film (ACF) 50. The first electrical wiring member 10 is a printed circuit board that is a rigid board.

### Structure of Electrical Connection Structure

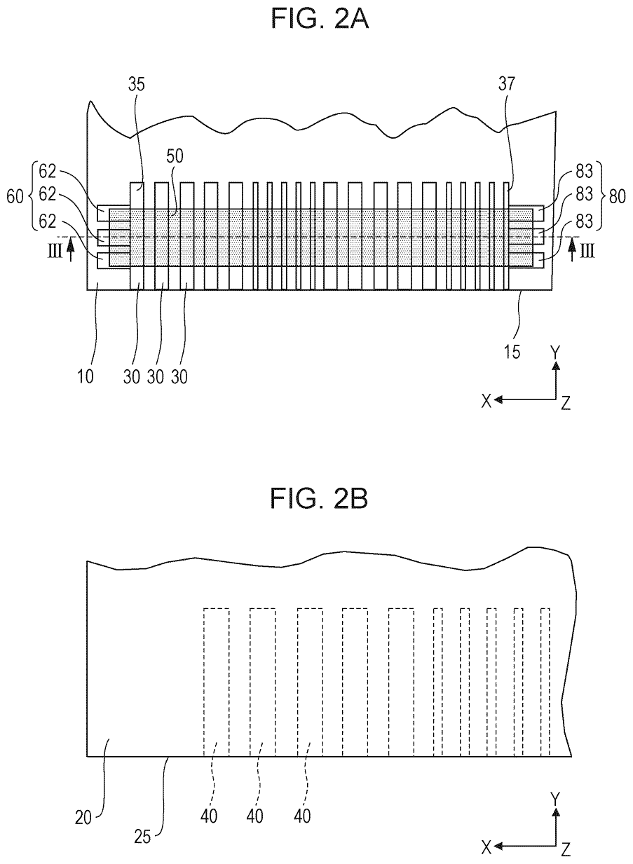

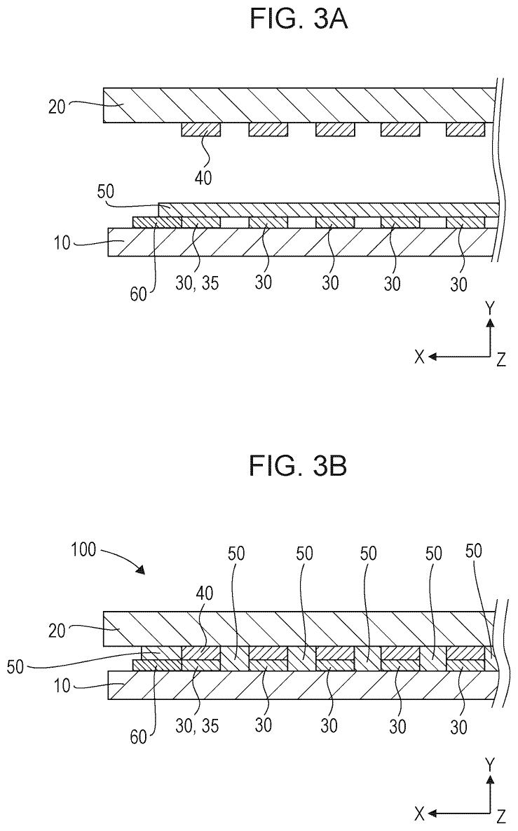

FIG. 2A is a plan view illustrating the first electrical wiring member 10 and the anisotropic conductive film 50, and FIG. 2B is a partial plan view illustrating a second electrical wiring member 20 as viewed from a surface opposite to a surface of the second electrical wiring member 20 in contact with the anisotropic conductive film 50. FIG. 3A is a partial cross-sectional view of the first electrical wiring member 10 and the second electrical wiring member 20 that are separated from each other. FIG. 3B is a partial cross-sectional view of the electrical connection structure 100 in which the first electrical wiring member 10 and the second electrical wiring member 20 have been adhered to each other via the anisotropic conductive film 50.

The first electrical wiring member 10 includes a plurality of leads (referred to below as first leads 30) having a raised shape. The first leads 30 are in contact with an edge portion 15 of the first electrical wiring member 10 and are arranged in one direction (the X direction) along the edge portion 15. Of the plurality of first leads 30, a first lead 30 located at one end portion in one direction (the X direction) is referred to as a first end lead 35, and a first lead 30 located at the other end portion is referred to as a second end lead 37. The second electrical wiring member 20 includes a plurality of leads (referred to below as second leads 40) having a raised shape. The second leads 40 are in contact with an edge portion 25 of the second electrical wiring member 20 and are arranged in one direction (the X direction) along the edge portion 25. The first electrical wiring member 10 further includes a first additional portion 60 and a second additional portion 80, which will be described later.

### Method of Manufacturing Electrical Connection Structure 100

A method of manufacturing the electrical connection structure 100 will be described with reference to FIGS. 2 to 3. First, as illustrated in FIG. 2A, the anisotropic conductive film 50, substantially rectangular as viewed in the Z direction, is pasted to the first lead 30 such that one side of the anisotropic conductive film 50 is parallel to the edge portion 15 of the first electrical wiring member 10. Next, as illustrated in FIG. 3A, the second electrical wiring member 20 is disposed above the anisotropic conductive film 50 such that the second leads 40 face the respective first leads 30 to be connected to the second leads 40. Then, the second electrical wiring member 20 is lowered until the second leads 40 are in contact with the anisotropic conductive film 50.

Next, the anisotropic conductive film 50 is heated and pressurized from above the second electrical wiring member 20 by using a thermocompression tool (not illustrated). As illustrated in FIG. 3B, some portions of the anisotropic conductive film 50 at least partially fill gaps between the first leads 30 and the second leads 40. A thermosetting resin in the anisotropic conductive film 50 is hardened by heating. Through the process described above, the anisotropic conductive film 50 physically connects the first electrical wiring member 10 and the second electrical wiring member 20 to each other and also electrically connects the first leads 30 and the second leads 40 to each other. Paste Device 200 and Paste Method of Anisotropic Conductive Film 50

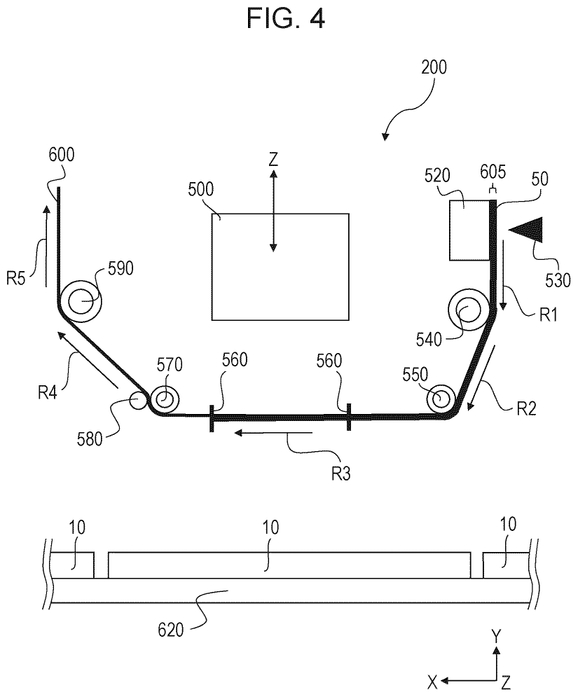

FIG. 4 is a conceptual diagram illustrating the structure of a paste device 200 of the anisotropic conductive film 50. The paste device 200 includes a half-cut table 520, a half-cut blade 530, a paste head 500, a plurality of guide rollers 540, 550, 570, and 590, and a peeling roller 580. The anisotropic conductive film 50 is joined to a separator film 600 to form a laminated film 605. The half-cut blade 530 is provided at a position facing the half-cut stand 520. The half-cut blade 530 moves in the X direction to cut the entire anisotropic conductive film 50 in the width direction. The anisotropic conductive film 50 is cut throughout the entire film thickness, but the separator film 600 is not cut. In the drawing, half-cut portions 560 directly above the first electrical wiring member 10 are illustrated. The paste head 500 can move in the Z direction. The paste head 500 heats and pressurizes the laminated film 605 from above the separator film 600 to paste the anisotropic conductive film 50 to the first leads 30.

A conveyor 620 that transports the first electrical wiring member 10 is provided below the paste head 500. The guide rollers 540, 550, and 570 guide the laminated film 605 to a position directly above the first electrical wiring member 10 by moving the laminated film 605 in the direction indicated by an arrow R1, an arrow R2, and an arrow R3. The peeling roller 580 works with the guide roller 570 and peels the separator film 600 from the anisotropic conductive film 50 pasted to the first electrical wiring member 10. The guide rollers 550, 570, and 590 guide the separator film 600 having been separated from the anisotropic conductive film 50 in the direction indicated by the arrow R3, an arrow R4, and an arrow R5.

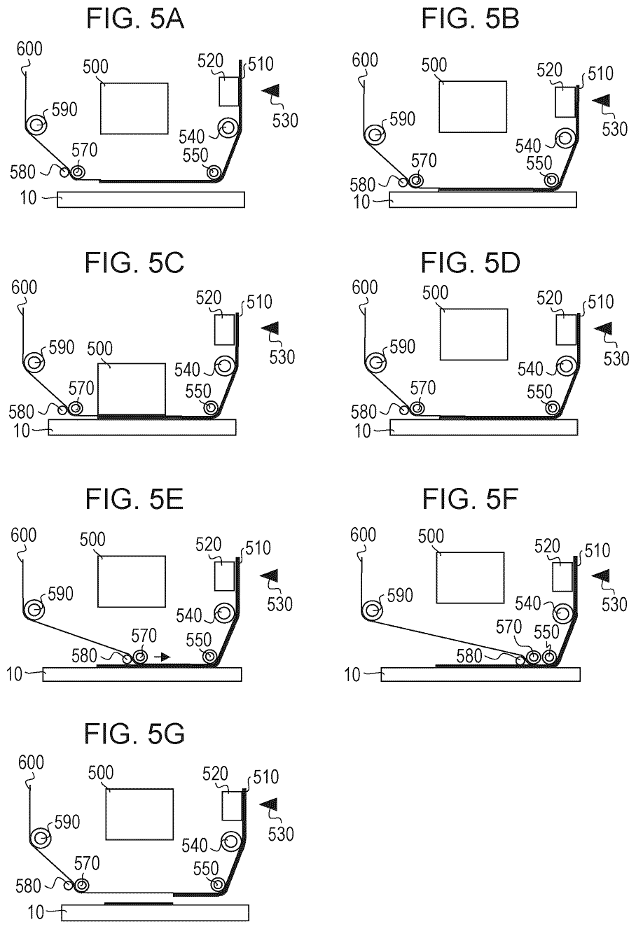

A process of pasting the anisotropic conductive film 50 to the first electrical wiring member 10 will be described with reference to FIG. 5. First, as illustrated in FIG. 5A, the portion (the portion between the two half-cut portions 560 in FIG. 4) to be pasted of the laminated film 605 is transported to a position below the paste head 500. The first electrical wiring member 10 is transported by the conveyor 620 to the position below the paste head 500 and remains stationary. Next, as illustrated in FIG. 5B, the guide rollers 550 and 570 and the peeling roller 580 are moved downward by a drive device (not illustrated), and the anisotropic conductive film 50 is placed on the first lead 30.

Next, as illustrated in FIG. 5C, the paste head 500 is moved downward until it comes into contact with the separator film 600. After that, the paste head 500 heats and pressurizes the anisotropic conductive film 50 via the separator film 600. This pastes the anisotropic conductive film 50 to the first lead 30. The heating and pressurizing can be performed for approximately one second. After that, as illustrated in FIG. 5D, the paste head 500 is moved upward and separated from the separator film 600.

Next, as illustrated in FIG. 5E, the guide roller 570 and the peeling roller 580 move in a direction opposite to the transport direction of the laminated film 605 while holding the separator film 600 therebetween. This peels the separator film 600 from the anisotropic conductive film 50. As illustrated in FIG. 5F, when the guide roller 570 and the peeling roller 580 have completed their movement, the separator film 600 is peeled from a portion of the anisotropic conductive film 50 that has been pasted to the first lead 30.

Next, as illustrated in FIG. 5G, the guide roller 570 and the peeling roller 580 are moved in the opposite direction to return to their original positions. Prior to or in parallel with this operation, the guide rollers 550 and 570 and the peeling roller 580 are moved upward to lift the separator film 600. The anisotropic conductive film 50 is pasted to one first electrical wiring member 10 by performing the process described above. After that, the process illustrated in FIGS. 5A to 5G is repeated.

### Paste Error of Anisotropic Conductive Film

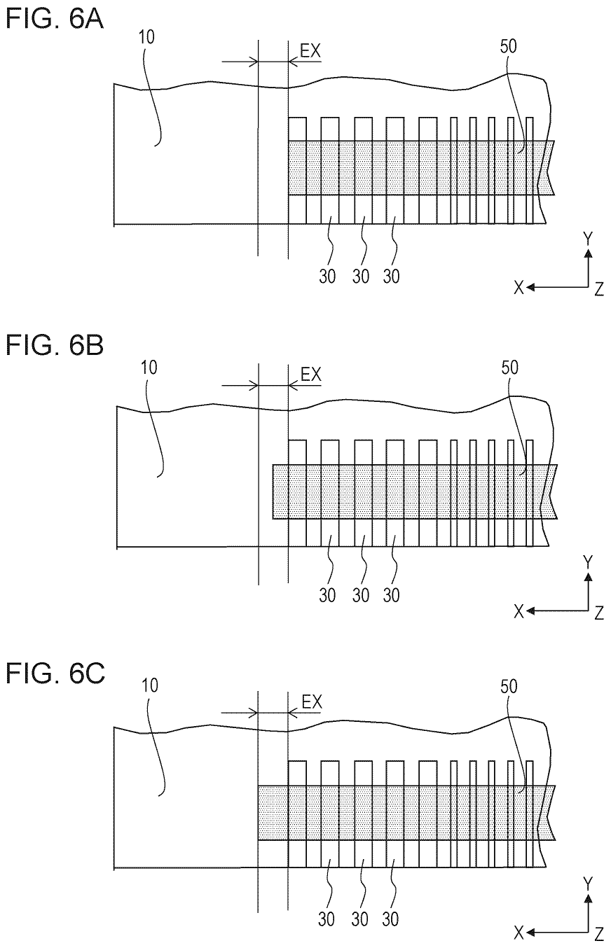

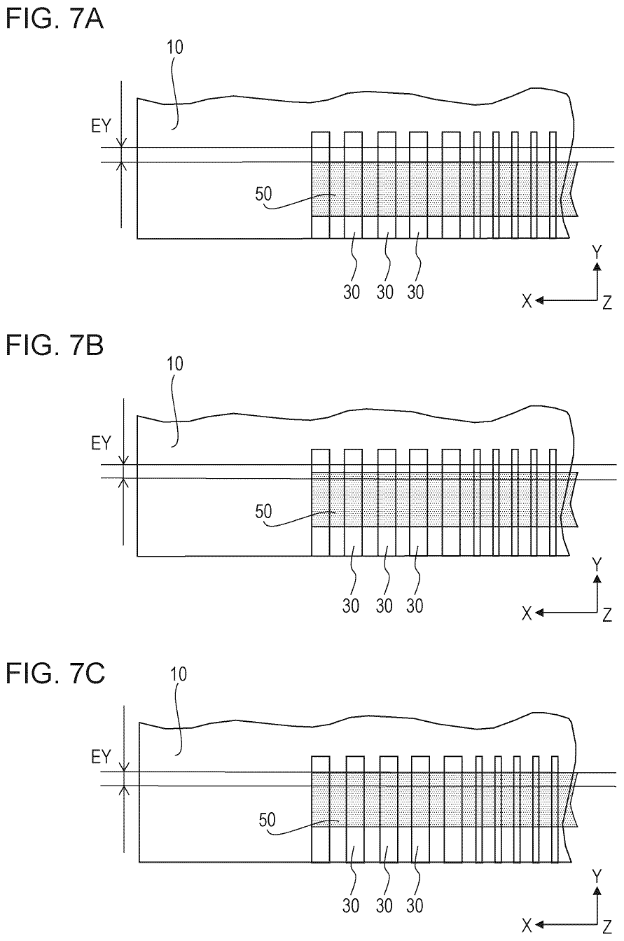

When the anisotropic conductive film 50 is pasted by the process illustrated in FIGS. 5A to 5G, a paste error in the X direction and a paste error in the Y direction may occur. FIGS. 6A to 6C illustrate a paste error of the anisotropic conductive film 50 in the X direction. In the embodiment, for example, a paste error EX of 0.2 mm in the X direction occurs. FIG. 6A illustrates a case in which the anisotropic conductive film 50 is shifted to the right, FIG. 6B illustrates a case in which the paste error is zero, and FIG. 6C illustrates a case in which the anisotropic conductive film 50 is shifted to the left. FIGS. 7A to 7C illustrate a paste error the anisotropic conductive film 50 in the Y direction. In the embodiment, for example, a paste error EY of 0.15 mm in Y direction occurs. FIG. 7A illustrates a case in which the anisotropic conductive film 50 is shifted to the front, FIG. 7B illustrates a case in which the paste error is zero, and FIG. 7C illustrates a case in which the anisotropic conductive film 50 is shifted to the back. However, since the length of the first lead 30 in the Y direction is generally greater than the width of the anisotropic conductive film 50 in the Y direction, the paste error in the Y direction is not a significant problem.

### Peeling of Anisotropic Conductive Film

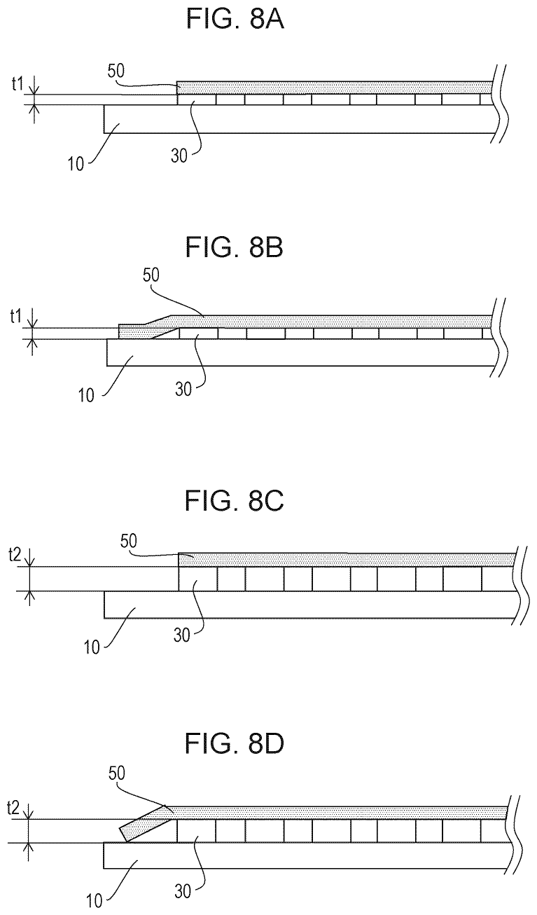

The anisotropic conductive film 50 having been pasted to the first electrical wiring member 10 may be peeled from the first electrical wiring member 10 when the separator film 600 is peeled. FIGS. 8A to 8D are side views illustrating states of an end portion of the anisotropic conductive film 50. FIGS. 8A and 8B illustrate cases in which a thickness t1 of the first lead 30 is approximately 40 μm. FIGS. 8C and 8D illustrate cases in which a thickness t2 of the first lead 30 is approximately 80 μm. FIGS. 8A and 8C correspond to FIG. 6A, and FIGS. 8B and 8D correspond to FIG. 6C. The thickness of the first lead 30 depends on the required performance of the liquid ejection head 1. A large amount of electric power is required to achieve high-precision and high-speed printing, but an increase in the width of the first lead 30 affects the size of the liquid ejection head 1. Accordingly, the thickness of the first lead 30 may be increased to support the increased electric power.

As illustrated in FIGS. 8A and 8C, when the end of the anisotropic conductive film 50 is present on (not protruding from) the first lead 30, the anisotropic conductive film 50 is less likely to be peeled. On the other hand, as illustrated in FIGS. 8B and 8D, when the end portion of the anisotropic conductive film 50 protrudes from the first lead 30, the anisotropic conductive film 50 is likely to be peeled starting from the end portion thereof. When the thickness of the first lead 30 is small, the end portion of anisotropic conductive film 50 drops from the first lead 30 and is pasted to the first electrical wiring member 10. However, when adhesion to the first electrical wiring member 10 is insufficient, the anisotropic conductive film 50 is likely to be peeled starting from the end portion thereof. When the thickness of the first lead 30 is great, the end portion of the anisotropic conductive film 50 drops from the first lead 30 but does not come into contact with the first electrical wiring member 10 or, if it comes into contact, the contact area is reduced. Accordingly, the anisotropic conductive film 50 is more likely to be peeled starting from the end portion thereof. This problem is likely to occur when the thickness of the first lead 30 is greater than the thickness of the anisotropic conductive film 50 and is more likely to occur when the thickness of the first lead 30 is 1.2 times or more the thickness of the anisotropic conductive film 50.

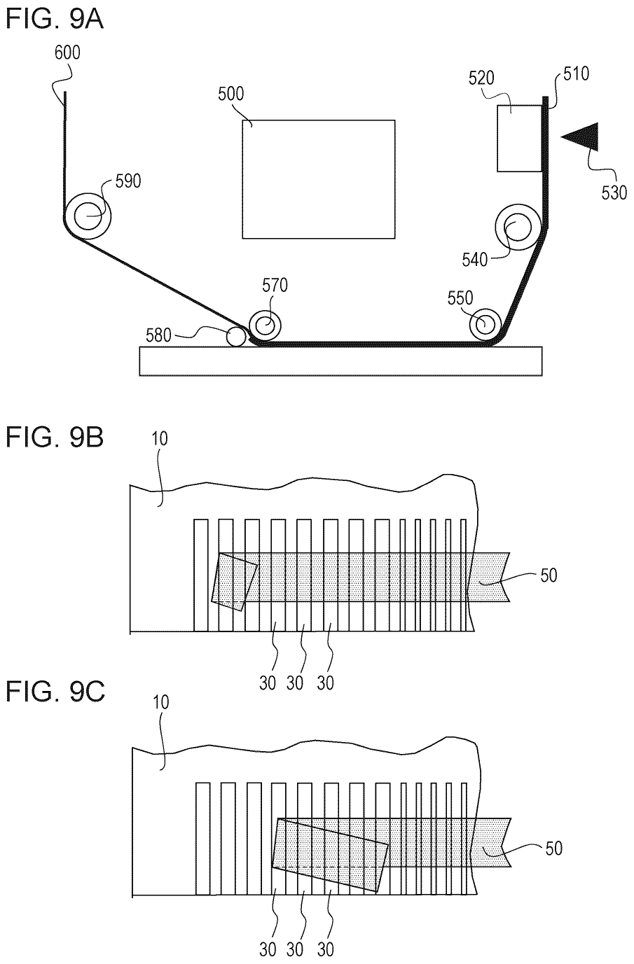

FIG. 9A schematically illustrates a mechanism by which the anisotropic conductive film 50 is peeled from the first electrical wiring member 10 at a position closer to a peeling start point of the separator film 600. When adhesion of the end portion of the anisotropic conductive film 50 is insufficient, the anisotropic conductive film 50 is pulled upward along with the separator film 600 when the separator film 600 is peeled by the peeling roller 580 and the guide roller 570 during transition from the state in FIG. 5D to the state in FIG. 5E. As a result, as illustrated in FIG. 9B, the anisotropic conductive film 50 is peeled from the first electrical wiring member 10. As illustrated in FIG. 9C, as the peeling progresses, the anisotropic conductive film 50 may be peeled from the plurality of first leads 30.

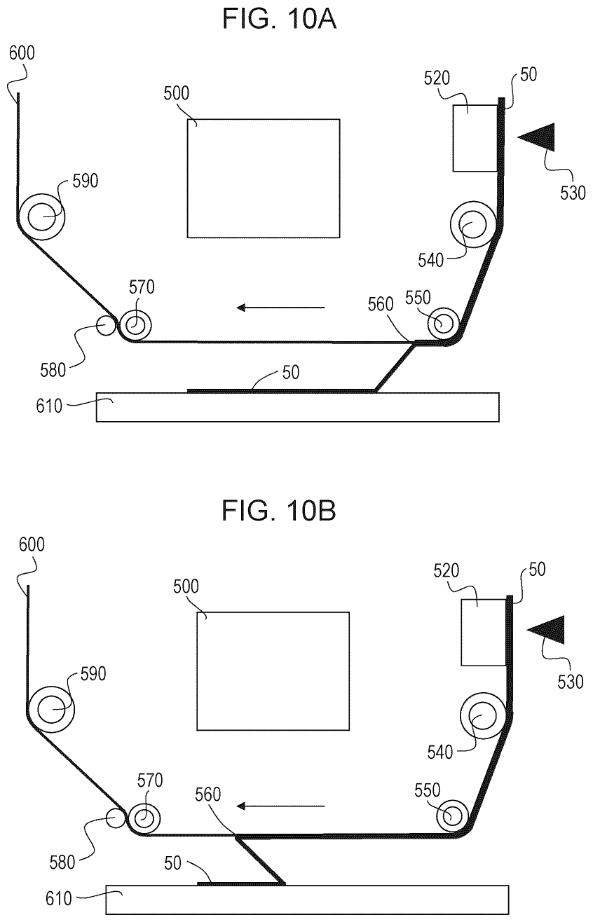

FIGS. 10A and 10B schematically illustrate a mechanism by which the anisotropic conductive film 50 is peeled from the first electrical wiring member 10 at a position closer to a peeling end point of the separator film 600. Since the anisotropic conductive film 50 is cut in advance as described above, during transition from the state in FIG. 5F to the state in FIG. 5G, the portion of the anisotropic conductive film 50 having been pasted to the first electrical wiring member 10 is separated from a subsequent portion of the anisotropic conductive film 50.

However, the cut portion of the anisotropic conductive film 50 may adhere to the subsequent portion of the anisotropic conductive film 50 again during a heating and pressurizing process illustrated in FIG. 5C. As illustrated in FIG. 10A, the portion of the anisotropic conductive film 50 having adhered to the subsequent portion of the anisotropic conductive film 50 again in the half-cut portion 560 is transported to the left together with the subsequent portion of the anisotropic conductive film 50 and is peeled from the first electrical wiring member 10. As illustrated in FIG. 10B, as the separator film 600 is transported, the range in which the anisotropic conductive film 50 is peeled from the first electrical wiring member 10 increases.

### Structure of Additional Portion

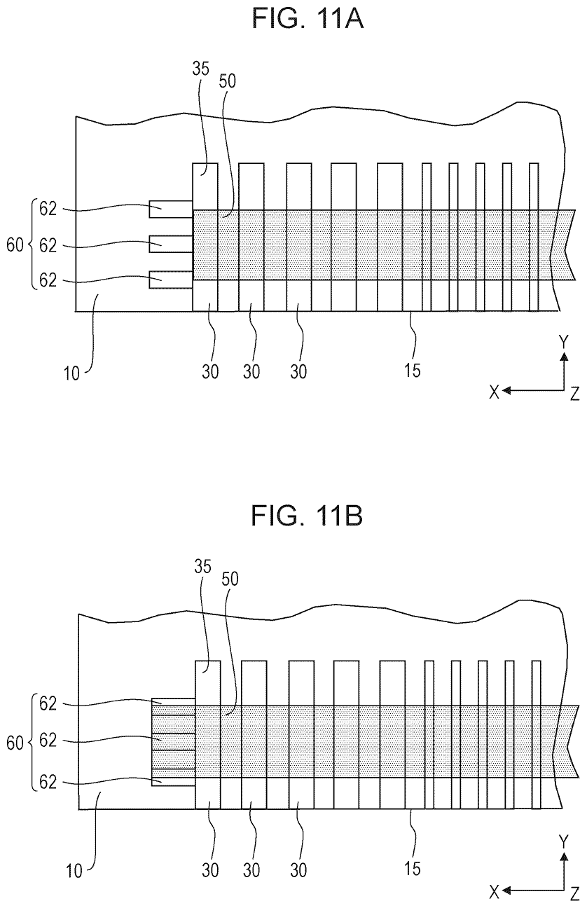

FIGS. 11A and 11B are partial plan views illustrating the first electrical wiring member 10. The first additional portion 60 is provided on a side closer to the start point at which the separator film 600 is peeled. The first additional portion 60 includes a plurality of (three in the embodiment) first branch portions 62. Each of the first branch portions 62 is an approximately rectangular parallelepiped member having a substantially rectangular shape as viewed in the Z direction. The first branch portions 62 extend substantially parallel to the X-direction. The first branch portions 62 can be made of the same material as the first leads 30. This can easily create the first electrical wiring member 10. In the embodiment, the first branch portions 62 are formed integrally with the first end lead 35. The thickness of the first additional portion 60 (the first branch portions 62) can be equal to the thickness of the first end lead 35. More specifically, when the thickness of the first additional portion 60 (the first branch portions 62) is not less than 80% and not more than 120% of the thickness of the first end lead 35, the effect of the present disclosure can be obtained. This improves the adhesiveness of the anisotropic conductive film 50 to the first additional portion 60 and the first end lead 35, and accordingly, the anisotropic conductive film 50 is less likely to be peeled.

A second additional portion 80 is provided on a side closer to the end point at which the separator film 600 is peeled. As illustrated in FIG. 2A, the second additional portion 80 includes a plurality of (three in the embodiment) third branch portions 83. The third branch portions 83 are in contact with the second end lead 37 in the X direction. The second additional portion 80 has a structure similar to that of the first additional portion 60 and is line-symmetric to the first additional portion 60 with respect to the Y direction. For the specific structure, refer to the description of the first additional portion 60. It should be noted that, in the paste device 200 having the peeling roller 580 on the left side as illustrated in FIG. 4, since the anisotropic conductive film 50 is more likely to be peeled at a position closer to the peeling start point of the separator film 600, the second additional portion 80 can be omitted. However, since the end portion at which peeling is more likely to occur may depend on a paste device, the first additional portion 60 can also be omitted.

The first additional portion 60 and the second additional portion 80 have a dimension (0.2 mm in the embodiment) in the X direction that is equal to at least paste error. FIG. 11A illustrates a case in which the anisotropic conductive film 50 is shifted to the right, and FIG. 11B illustrates a case in which the anisotropic conductive film 50 is shifted to the left. In addition, in the embodiment, the first additional portion 60 is in contact with the first end lead 35 in the X direction, and the second additional portion 80 is in contact with the second end lead 37 in the X direction. Accordingly, regardless of the position of the end portion of the anisotropic conductive film 50 within the range of paste error in the X direction, one end of the anisotropic conductive film 50 is present above the first additional portion 60, and the other end is present above the second additional portion 80. In other words, it is possible to avoid a situation in which the end portion of the anisotropic conductive film 50 floats in the air over its entire width.

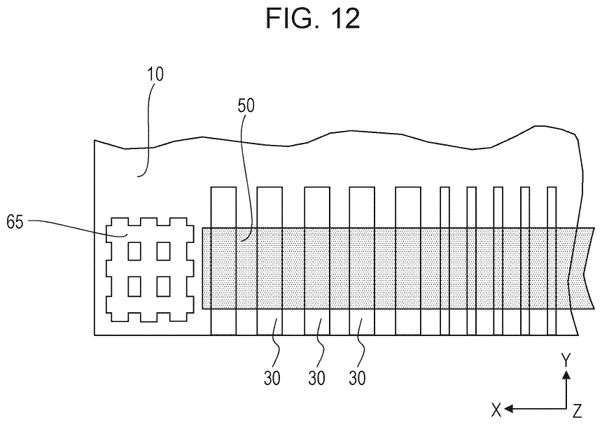

FIG. 12 illustrates a comparative example in which a dummy lead is provided beside the first lead 30, as described in Japanese Patent Laid-Open No. 2004-6632. A dummy lead 65 is spaced apart from the first lead 30.

Accordingly, when the end portion of the anisotropic conductive film 50 is located between the dummy lead 65 and the first lead 30 as illustrated in the drawing, the end portion of the anisotropic conductive film 50 floats in the air over its entire width and is likely to be peeled from the first electrical wiring member 10. It should be noted that, since the dummy lead 65 has a lattice shape as viewed in the Z direction, the air trapped inside the lattice may expand when the second electrical wiring member 20 is heated and joined and may affect the joint of the second electrical wiring member 20. Since the first additional portion 60 and the second additional portion 80 according to the embodiment do not have a sealed portion, such a problem is unlikely to occur.

### Modifications

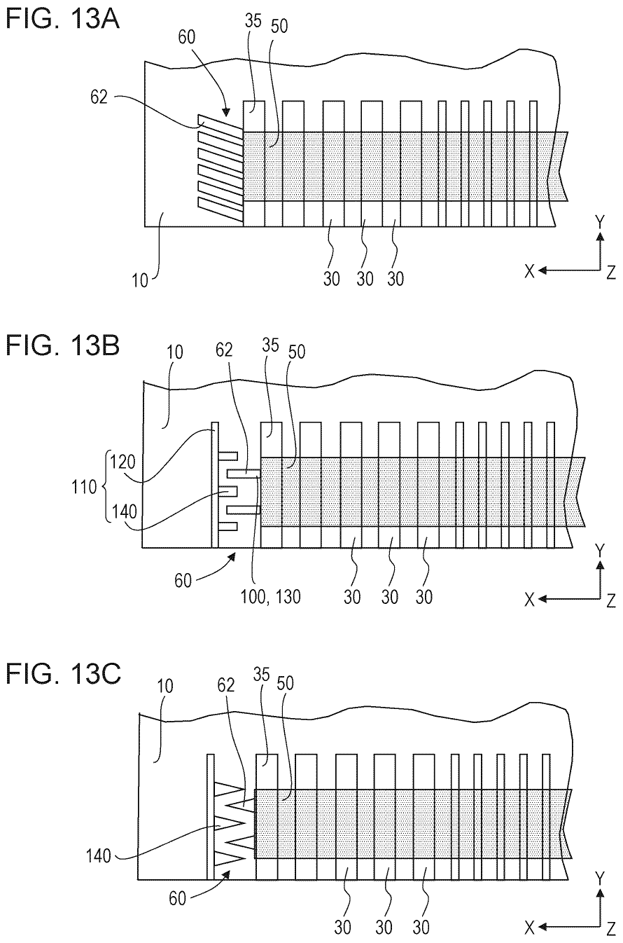

The shapes of the first additional portion 60 and the second additional portion 80 are not limited to those in the first embodiment. Modifications of the first additional portion 60 will be described below, but the same applies to the second additional portion 80. In addition, the components and the effects that are not described are the same as those in the first embodiment. Referring to FIG. 13A, the additional portion 60 includes a plurality of (six in the embodiment) first branch portions 62 that are substantially parallelogrammatic as viewed in the Z direction. The plurality of first branch portions 62 extends in a direction oblique to the X direction.

The direction of the first branch portions 62 oblique to the X direction is not limited to the example in FIG. 13A but may be lower left from the connection portion connected to the first end lead 35.

Referring to FIG. 13B, the first additional portion 60 includes a first auxiliary additional portion 110 located on the side opposite to the first end lead 35 with the first branch portions 62 therebetween. The first auxiliary additional portion 110 includes a main portion 120 extending parallel to the first end lead 35 and a plurality of second branch portions 140 in contact with the main portion 120. The plurality of first branch portions 62 and the plurality of second branch portions 140 are arranged alternately in the Y direction and partially overlap each other as viewed in the Y direction. Accordingly, regardless of the position of the end portion of the anisotropic conductive film 50 within the range of paste error in the X direction, the end portion of the anisotropic conductive film 50 is in contact with the first additional portion 60. Although not illustrated, an auxiliary additional portion having the same shape as the first auxiliary additional portion 110 can also be provided on a second end lead 37 side. Referring to FIG. 13C, the first branch portions 62 and the second branch portions 140 are substantially triangular and the remaining structure is the same as that of the modification illustrated in FIG. 13B.

According to the present disclosure, an electrical connection structure in which an anisotropic conductive film is less likely to be peeled can be provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-129445, filed Aug. 8, 2023, which is hereby incorporated by reference herein in its entirety.

What is claimed is:

1. A liquid ejection head having an electrical connection structure, the electrical connection structure comprising:
a plurality of first leads having a raised shape and arranged in one direction along an edge portion of a first electrical wiring member;
a plurality of second leads arranged in the one direction along an edge portion of a second electrical wiring member, the second leads facing the corresponding first leads; and
an anisotropic conductive film located between the plurality of first leads and the plurality of second leads, the anisotropic conductive film electrically connecting the plurality of first leads and the corresponding plurality of second leads to each other,
wherein the plurality of first leads includes a first end lead located at one end portion in the one direction, and
the first electrical wiring member includes a first additional portion having a raised shape, at least a portion of the first additional portion being in contact with the first end lead in the one direction.

2. The liquid ejection head according to claim 1,
wherein a thickness of the first additional portion is not less than 80% and not more than 120% of a thickness of the first end lead.

3. The liquid ejection head according to claim 1,
wherein the first additional portion and the plurality of first leads are made of the same material.

4. The liquid ejection head according to claim 1,
wherein the first additional portion includes a plurality of first branch portions in contact with the first end lead.

5. The liquid ejection head according to claim 4,
wherein the plurality of first branch portions extends substantially parallel to the one direction.

6. The liquid ejection head according to claim 4,
wherein the plurality of first branch portions extends in a direction oblique to the one direction.

7. The liquid ejection head according to claim 4,
wherein the first branch portions are substantially rectangular as viewed in a direction orthogonal to a surface of the first electrical wiring member on which the plurality of first leads is arranged.

8. The liquid ejection head according to claim 4,
wherein the first branch portions are substantially triangular as viewed in a direction orthogonal to a surface of the first electrical wiring member on which the first leads are arranged.

9. The liquid ejection head according to claim 4,
wherein the first additional portion includes a first auxiliary additional portion located on a side opposite to the first end lead with the first branch portions therebetween, and
the first auxiliary additional portion includes a main portion extending parallel to the first end lead and a plurality of second branch portions in contact with the main portion, and the plurality of first branch portions and the plurality of second branch portions are alternately arranged and partially overlap each other as viewed in a direction orthogonal to the one direction and parallel to the anisotropic conductive film.

10. The liquid ejection head according to claim 1,
wherein the plurality of first leads includes a second end lead located at an end portion on a side opposite to the first end lead, and
the first electrical wiring member includes a second additional portion having a raised shape, at least a portion of the second additional portion being in contact with the second end lead in the one direction.

11. The liquid ejection head according to claim 1,
wherein the first electrical wiring member is a printed circuit board, and the second electrical wiring member is a flexible wiring board.

12. The liquid ejection head according to claim 1,
wherein a thickness of the first lead is greater than a thickness of the anisotropic conductive film.

13. A method of manufacturing a liquid ejection head, comprising:
placing, on a first electrical wiring member, a laminated film including an anisotropic conductive film and a separator film laminated together such that the anisotropic conductive film is in contact with the first electrical wiring member;
peeling the separator film from the anisotropic conductive film placed on the first electrical wiring member; and
placing a second electrical wiring member on the anisotropic conductive film from which the separator film has been peeled,
wherein the liquid ejection head has an electrical connection structure, the electrical connection structure including a plurality of first leads having a raised shape is arranged in one direction along an edge portion of the first electrical wiring member, a plurality of second leads having a raised shape is arranged in the one direction along an edge portion of the second electrical wiring member, and the second electrical wiring member is arranged such that the plurality of first leads faces the corresponding second leads,
the plurality of first leads includes a first end lead located at one end portion in the one direction, and the first electrical wiring member includes a first additional portion having a raised shape, at least a portion of the first additional portion being in contact with the first end lead in the one direction, and
the anisotropic conductive film has the one end portion in the one direction located on the first additional portion.

14. The method of manufacturing a liquid ejection head according to claim 13,
wherein the anisotropic conductive film of the laminated film is substantially rectangular, and the laminated film is placed on the first electrical wiring member such that one side of the anisotropic conductive film is substantially parallel to the edge portion of the first electrical wiring member.

15. The method of manufacturing a liquid ejection head according to claim 13, further comprising:
providing the first additional portion on a side closer to a start point at which the separator film is peeled.
